(19) United States
(12) Patent Application Publication
(10) Pub. No.: US 2012/0135305 A1
(43) Pub. Date: May 31, 2012

(54) Positive Active Material for Rechargeable Lithium Battery, Method of Preparing the Same, and Rechargeable Lithium Battery Including the Same

(75) Inventors: Chang-Hyuk Kim, Yongin-si (KR); Do-Hyung Park, Yongin-si (KR); Seon-Young Kwon, Yongin-si (KR); Min-Han Kim, Yongin-si (KR); Ji-Hyun Kim, Yongin-si (KR); Jeong-Seop Lee, Yongin-si (KR); Yoon-Chang Kim, Yongin-si, (KR)

(73) Assignee: SAMSUNG SDI CO., LTD., Yongin-si (KR)

(21) Appl. No.: 13/220,016

(22) Filed: Aug. 29, 2011

(30) Foreign Application Priority Data
Nov. 25, 2010 (KR) 10-2010-0118328

(51) Int. Cl. H01M 4/583; H01M 4/64; H01M 4/525

(52) U.S. Cl. 429/211; 429/231.8; 429/223; 252/182.1

(57) ABSTRACT

A positive active material of a positive electrode of a rechargeable lithium battery, the positive active material includes a core and a composite surrounding a surface of the core and including a phosphate-based compound and a carbon-based compound. The core being a nickel-based oxide having the chemical formula Liₐ(NiₓCo_{y}Mn_{z})₂₋ₐO₂ where 1.01≦a≦1.2, 0.5≦x≦1, 0≦y≦0.5, and 0≦z≦0.5, the phosphate-based compound being one of Li₃PO₄, P₂O₅, H₃PO₄, (NH₄)₂HPO₄, NH₄H₂PO₄ and a combination thereof, the carbon-based compound being obtained from a precursor, the precursor being one of sucrose, denka black, carbon black and a combination thereof.

### CLAIM OF PRIORITY

This application makes reference to, incorporates the same herein, and claims all benefits accruing under 35 U.S.C. §119 from an application for POSITIVE ACTIVE MATERIAL FOR RECHARGEABLE LITHIUM BATTERY, METHOD OF PREPARING THE SAME, AND RECHARGEABLE LITHIUM BATTERY INCLUDING THE SAME earlier filed in the Korean Intellectual Priority Office on 25 Nov. 2010 and there duly assigned Serial No. 10-2010-0118328.

### BACKGROUND OF THE INVENTION

1. Field of the Invention

This disclosure relates to a positive active material for a rechargeable lithium battery, a method of manufacturing the same, and a rechargeable lithium battery including the same.

2. Description of the Related Art

In recent times, due to reductions in size and weight of portable electronic equipment, there has been a need to develop batteries for the portable electronic equipment that have both high performance and large capacity.

The rechargeable lithium battery is manufactured by injecting electrolyte into a battery cell, which includes a positive electrode including a positive active material capable of intercalating/deintercalating lithium ions and a negative electrode including a negative active material capable of intercalating/deintercalating lithium ions.

For a positive active material, LiCoO₂ is widely used. However, since cobalt (Co) is a rare metal, it is expensive and has a problem of unstable supply. Accordingly, a positive active material including Ni (nickel) or Mn (manganese) has been researched.

Meanwhile, a positive active material including Ni (nickel) can provide a high-capacity and high voltage battery. However, the positive active material has an unstable structure and thus, decreases capacity. Also, due to a reaction with an electrolyte, it has thermal instability.

### SUMMARY OF THE INVENTION

An exemplary embodiment of this disclosure provides a positive active material for a rechargeable lithium battery which has high-capacity and high voltage characteristics and excellent thermal stability, ion conductivity, and electrical conductivity.

Another embodiment of this disclosure provides a method of manufacturing the positive active material.

Yet another embodiment of this disclosure provides a rechargeable lithium battery including the positive active material.

Still another embodiment of this disclosure provides a rechargeable lithium battery including the positive electrode.

According to one aspect of the present invention, there is provided a positive active material that includes a core and a composite surrounding a surface of the core and including a phosphate-based compound and a carbon-based compound. The core may include a nickel-based oxide. The core may include a compound represented by the chemical formula Liₐ(NiₓCo_{y}Mn_{z})₂₋ₐO₂, where 1.01≦a≦1.2, 0.5≦x≦1, 0≦y≦0.5, and 0≦z≦0.5. The phosphate-based compound may include one of Li₃PO₄, P₂O₅, H₃PO₄, (NH₄)₂HPO₄, NH₄H₂PO₄, and a combination thereof. The carbon-based compound may be obtained from a precursor that includes one of sucrose, denka black, carbon black and a combination thereof. The positive active material may have a structure where the surface of the core is coated with the composite. The composite may be included in an amount of about 0.01 part by weight to about 50 parts by weight based on 100 parts by weight of the core.

Alternately, the present invention provides a positive electrode that includes a positive current collector and the positive active material as described above arranged on the current collector. Alternately, the present invention may provide a rechargeable lithium battery that includes a positive electrode including a positive current collector and the positive active material as described above arranged on the positive current collector, a negative electrode including a negative current collector and a negative active material arranged on the negative current collector and an electrolyte solution.

According to another aspect of the present invention, there is provided a method of preparing a positive active material, including acquiring a first mixture by mixing together a phosphate-based compound and a precursor of a carbon-based compound, acquiring a second mixture by mixing together the first mixture and a core material and heat-treating the second mixture to prepare a positive active material, wherein the core material is surrounded by a composite including the phosphate-based compound and the carbon-based compound. The first mixture may be acquired by further adding a solvent. The heat treatment may be performed at a temperature of about 300° C. to about 800° C. The core material may include a nickel-based oxide. The phosphate-based compound may include one of Li₃PO₄, P₂O₅, H₃PO₄, (NH₄)₂HPO₄, NH₄H₂PO₄ and a combination thereof. The precursor of the carbon-based compound may include one of sucrose, denka black, carbon black and a combination thereof.

According to another aspect of the present invention, there is provided a method of preparing a positive active material, including acquiring a mixture by mixing together a phosphate-based compound, a precursor of a carbon-based compound and a core material and heat-treating the mixture to prepare a positive active material, wherein the core material is surrounded by a composite that includes the phosphate-based compound and the carbon-based compound. The heat treatment may be performed at a temperature of about 300° C. to about 800° C. The core material may include a nickel-based oxide. The phosphate-based compound may include one of Li₃PO₄, P₂O₅, H₃PO₄, (NH₄)₂HPO₄, NH₄H₂PO₄ and a combination thereof. The precursor of the carbon-based compound may include one of sucrose, denka black, carbon black and a combination thereof.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view of a rechargeable lithium battery according to one embodiment of this disclosure;

FIG. 2 is a SEM photograph of the positive active material according to Example 1;

FIG. 3 is a SEM photograph of a positive active material according to Comparative Example 1; and

FIG. 4 is a DSC graph of the positive active materials prepared according to Example 1 and Comparative Example 1.

### DETAILED DESCRIPTION OF THE INVENTION

Exemplary embodiments of the present disclosure will hereinafter be described in detail. However, these embodiments are only exemplary, and this disclosure is not limited thereto.

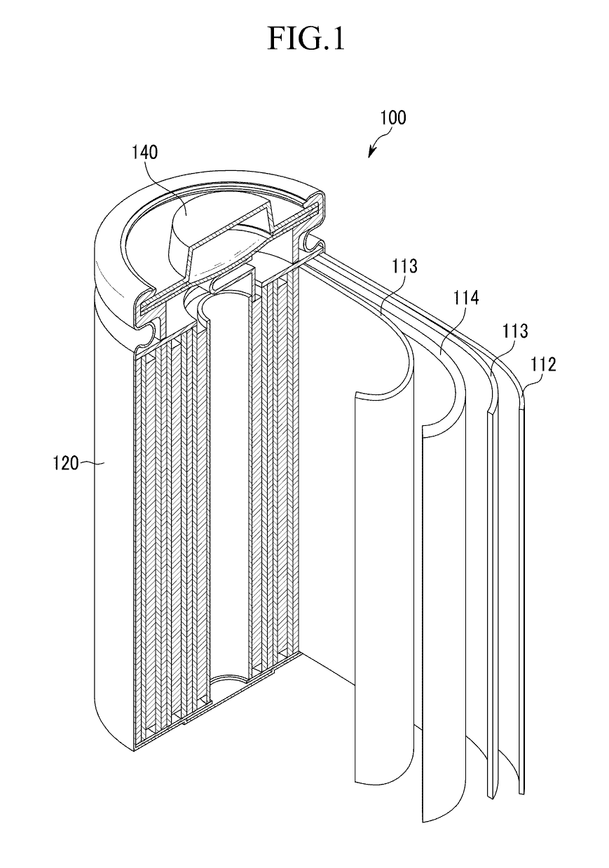

The rechargeable lithium battery according to one embodiment is described referring to FIG. 1. FIG. 1 is a schematic view of a rechargeable lithium battery 100 according to one embodiment of this disclosure. Referring now to FIG. 1, the rechargeable lithium battery 100 includes a negative electrode 112, a positive electrode 114, a separator 113 interposed between the negative electrode 112 and the positive electrode 114, an electrolyte (not shown) impregnating the separator 113, a battery case 120, and a sealing member 140 sealing the battery case 120.

The positive electrode 114 includes a current collector and a positive active material layer disposed on the current collector. The current collector may be aluminum (Al), but is not limited thereto. The positive active material layer includes a positive active material, a binder, and optionally a conductive material.

According to one embodiment of this disclosure, the positive active material includes a core and a composite surrounding the surface of the core, and the composite includes a phosphate-based compound and a carbon-based compound.

The core may include a nickel (Ni)-based oxide. The Ni-based oxide is inexpensive and may be used for a high-capacity and high-voltage rechargeable lithium battery. For the core, a compound represented by the following Chemical Formula 1 may be used.

Liₐ(NiₓCo_{y}Mn_{z})₂₋ₐO₂ [Chemical Formula 1]

In Chemical Formula 1, 1.01≦a≦1.2, 0.5≦x≦1, 0≦y≦0.5, and 0≦z≦0.5.

The phosphate-based compound has a high ion conductivity for lithium ions and a high structural stability. Accordingly, when the surface of the core is coated with a composite including the phosphate-based compound, the thermal and structural instability of the Ni-based oxide may be supplemented, and rate capabilities due to a decrease in the ion conductivity for lithium ions that may occur during the coating may be prevented from decreasing.

The phosphate-based compound may include Li₃PO₄, P₂O₅, H₃PO₄, (NH₄)₂HPO₄, NH₄H₂PO₄, or a combination thereof.

Since the carbon-based compound has a high electrical conductivity. When the surface of the core is coated with the composite including the carbonate-based compound, the electrical conductivity of the positive active material may be improved.

The carbon-based compound may include a compound obtained from a precursor of sucrose, denka black, carbon black, or a combination thereof.

Accordingly, the composite including the phosphate-based compound and the carbon-based compound may simultaneously provide the positive active material with thermal and structural stability, ion conductivity and electrical conductivity.

The positive active material may have a structure where the surface of the core is coated with the composite. The coating process may include a spray coating technique and an immersion technique, but this disclosure is not limited to them.

The composite may be included in an amount of about 0.01 part by weight to about 50 parts by weight based on 100 parts by weight of the core. According to one embodiment, the composite may be included in an amount of about 0.01 part by weight to about 20 parts by weight. According to another embodiment, the composite may be included in an amount of about 0.01 part by weight to about 10 parts by weight. When the composite is included within the range, excellent thermal and structural stability, ion conductivity and electrical conductivity may be acquired.

According to the embodiment, the positive active material includes acquiring a first mixture by mixing a phosphate-based compound and a carbon-based compound precursor, acquiring a second mixture by mixing the first mixture with a core material, and performing a heat treatment onto the second mixture.

The first mixture may further include a solvent. The solvent includes water, ethanol, isopropyl alcohol, but is not limited thereto. As for the core material, a Ni-based oxide may be used, as mentioned above. According to one embodiment, a compound represented by the above Chemical Formula 1 may be used.

According to the another embodiment, the positive active material may be prepared by acquiring a mixture by mixing a phosphate-based compound, a carbon-based compound precursor, and a core material, and performing a heat treatment onto the mixture.

The phosphate-based compound may include Li₃PO₄, P₂O₅, H₃PO₄, (NH₄)₂HPO₄, NH₄H₂PO₄, or a combination thereof. The carbon-based compound precursor may include sucrose, denka black, carbon black, or a combination thereof.

The heat treatment may be performed at a temperature ranging from about 300° C. to about 800° C. According to one embodiment, the heat treatment may be performed at a temperature ranging from about 400° C. to about 600° C. When the heat treatment is performed within the temperature range, the composite including the phosphate-based compound and the carbon-based compound precursor is transformed into a composite including the phosphate-based compound and a carbon-based compound and coats the core material.

The positive active material, which is prepared according to the above-described method and has a structure where the surface of the core is coated with the composite, may simultaneously acquire high-capacity and high voltage characteristics and have excellent thermal and structural stability, ion conductivity and electrical conductivity.

The binder improves binding properties of the positive active material particles to each other and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinyl chloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used in order to improve conductivity of an electrode. Any electrically conductive material may be used as a conductive material unless it causes a chemical change. Examples of the conductive material include natural graphite, artificial graphite, carbon black, acetylene black, ketjen black, a carbon fiber, a metal powder or a metal fiber including copper, nickel, aluminum, silver, and so on, and a polyphenylene derivative.

The negative electrode 112 includes a negative current collector and a negative active material layer disposed on the negative current collector. The current collector may include a copper foil, a nickel foil, a stainless steel foil, a titanium foil, a nickel foam, a copper foam, a polymer substrate coated with a conductive metal, and combinations thereof, but is not limited thereto. The negative active material layer includes a negative active material, a binder, and optionally a conductive material.

The negative active material includes a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions includes a carbon material. The carbon material may be any generally-used carbon-based negative active material in a lithium ion rechargeable battery.

Examples of the carbon material include crystalline carbon, amorphous carbon, and a mixture thereof. The crystalline carbon may be non-shaped, or may be sheet, flake, spherical, or fiber shaped natural graphite or artificial graphite. The amorphous carbon may be a soft carbon, a hard carbon, mesophase pitch carbonized products, fired coke, and the like.

Examples of the lithium metal alloy include lithium and a metal selected from the group consisting of Na, K, Rb, Cs, Fr, Be, Mg, Ca, Sr, Si, Sb, Pb, In, Zn, Ba, Ra, Ge, Al, and Sn.

Examples of the material being capable of doping and dedoping lithium include Si, SiOₓ (0≦x≦2), a Si—Y alloy (where Y is an element selected from the group consisting of an alkali metal, an alkaline-earth metal, a group 13 element, a group 14 element, a group 15 element, a group 16 element, a transition element, a rare earth element, and combinations thereof, and is not Si), Sn, SnO₂, a Sn—Y alloy (where Y is an element selected from the group consisting of an alkali metal, an alkaline-earth metal, a group 13 element, a group 14 element, a group 15 element, a group 16 element, a transition element, a rare earth element, and combinations thereof and is not Sn), or mixtures thereof. At least one of these materials may be mixed with SiO₂. The element Y may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

Examples of the transition metal oxide include vanadium oxide, lithium vanadium oxide, and the like.

The binder improves binding properties of the negative active material particles to each other and to a current collector. Examples of the binder include at least one selected from the group consisting of polyvinyl alcohol, carboxylmethyl cellulose, hydroxypropyl cellulose, polyvinyl chloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Any electrically conductive material may be used as a conductive material unless it causes a chemical change. Examples of the conductive material include carbon-based materials such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; and mixtures thereof.

The positive electrode 114 and negative electrode 112 may be manufactured by a method including mixing the active material, a conductive material, and a binder in an organic solvent to provide an active material composition, and coating the composition on a current collector.

The electrode manufacturing method is well known, and thus is not described in detail in the present specification. The solvent may be N-methylpyrrolidone, but it is not limited thereto.

The electrolyte solution includes a non-aqueous organic solvent and a lithium salt.

The non-aqueous organic solvent serves as a medium for transmitting ions taking part in the electrochemical reaction of the battery. The non-aqueous organic solvent may include a carbonate-based, ester-based, ether-based, ketone-based, alcohol-based, or aprotic solvent.

Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and the like.

When a linear carbonate compound and a cyclic carbonate compound are mixed with each other, the dielectric constant increases and the viscosity decreases. The cyclic carbonate compound and linear carbonate compound are mixed together in the volume ratio of about 1:1 to about 1:9.

Examples of the ester-based solvent may include methyl acetate, ethyl acetate, n-propyl acetate, dimethylacetate, methylpropionate, ethylpropionate, Y-butyrolactone, decanolide, valerolactone, mevalonolactone, caprolactone, and the like. Examples of the ether-based solvent include dibutylether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like.

The non-aqueous organic solvent may be used singularly or in a mixture. When the organic solvent is used in a mixture, the mixture ratio may be controlled in accordance with a desirable battery performance.

The non-aqueous electrolyte may further include an overcharge-inhibiting compound such as ethylene carbonate, pyrocarbonate, and the like.

The lithium salt supplies lithium ions to the battery, and performs a basic operation of a rechargeable lithium battery and improves lithium ion transport between positive and negative electrodes.

Examples of the lithium salt include LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂ (lithium bis(oxalato)borate; LiBOB), or a combination thereof.

The lithium salt may be used at a concentration ranging from about 0.1 M to about 2.0 M. When the lithium salt is included at the concentration range, electrolyte performance and lithium ion mobility may be enhanced due to optimal electrolyte conductivity and viscosity.

The separator 113 may be formed as a single layer or a multilayer, and may be made out of polyethylene, polypropylene, polyvinylidene fluoride, or a combination thereof.

The following examples illustrate this disclosure in more detail. These examples, however, are not in any sense to be interpreted as limiting the scope of this disclosure. Furthermore, what is not described in this specification may be sufficiently understood by those who have ordinary skill in the art and will not be illustrated here. (Preparation of Positive Active Material)

### EXAMPLE 1

NH₄H₂PO₄, sucrose and ethanol were mixed and then the mixture was evenly mixed with 100 g of Li_{1.05}(Ni_{0.5}Co_{0.2}Mn_{0.3})_{0.95}O₂. The resulting mixture was baked in a furnace at about 500° CC for about 3 hours to prepare a positive active material having a structure where the surface of Li_{1.05} (Ni_{0.5}Co_{0.2}Mn_{0.3})_{0.95}O₂ was coated with a composite including NH₄H₂PO₄ and carbon. In this example, the composite was included in an amount of about 0.1 part by weight based on 100 parts by weight of Li_{1.05} (Ni_{0.5}Co_{0.2}Mn_{0.3})_{0.95}O₂.

### EXAMPLE 2

Li₃PO₄, sucrose, Li_{1.05} (Ni_{0.5}Co_{0.2}Mn_{0.3})_{0.95}O₂ were mixed and then the mixture was baked in a furnace at about 500° C. for about 3 hours to prepare a positive active material having a structure where the surface of Li_{1.05} (Ni_{0.5}Co_{0.2}Mn_{0.3})_{0.95}O₂ was coated with a composite including Li₃PO₄ and carbon. In this example, the composite was included in an amount of about 0.1 part by weight based on 100 parts by weight of Li_{1.05} (Ni_{0.5}Co_{0.2}Mn_{0.3})_{0.95}O₂.

### COMPARATIVE EXAMPLE 1

Li_{1.05} (Ni_{0.5}Co_{0.2}Mn_{0.3})_{0.95}O₂ was used as a positive active material.

COMPARATIVE EXAMPLE 2

NH₄H₂PO₄ was evenly mixed with Li_{1.05} (Ni_{0.5}Co_{0.2}Mn_{0.3})_{0.95}O₂, the mixture was agitated at a room temperature of about 20° C. to about 30° C. for about 2 hours, and the resulting product was heat-treated in a furnace at about 500° C. for about 3 hours to prepare a positive active material having a structure where the surface of Li_{1.05} (Ni_{0.5}Co_{0.2}Mn_{0.3})_{0.95}O₂ was coated with NH₄H₂PO₄. In this example, the NH₄H₂PO₄ was included in an amount of about 0.1 part by weight based on 100 parts by weight of Li_{1.05} (Ni_{0.5}Co_{0.2}Mn_{0.3})_{0.95}O₂.

### COMPARATIVE EXAMPLE 3

Sucrose was evenly mixed with Li_{1.05} (Ni_{0.5}Co_{0.2}Mn_{0.3})_{0.95}O₂, the mixture was agitated at a room temperature of about 20° C. to about 30° C. for about 2 hours, and the resulting product was heat-treated in a furnace at about 500° C. for about 3 hours to prepare a positive active material having a structure where the surface of Li_{1.05} (Ni_{0.5}Co_{0.2}Mn_{0.3})_{0.95}O₂ was coated with carbon. In this example, the carbon was included in an amount of about 0.1 part by weight based on 100 parts by weight of Li_{1.05} (Ni_{0.5}Co_{0.2}Mn_{0.3})_{0.95}O₂.

### EXPERIMENTAL EXAMPLE 1

### SEM or TEM Photograph of Positive Active Material

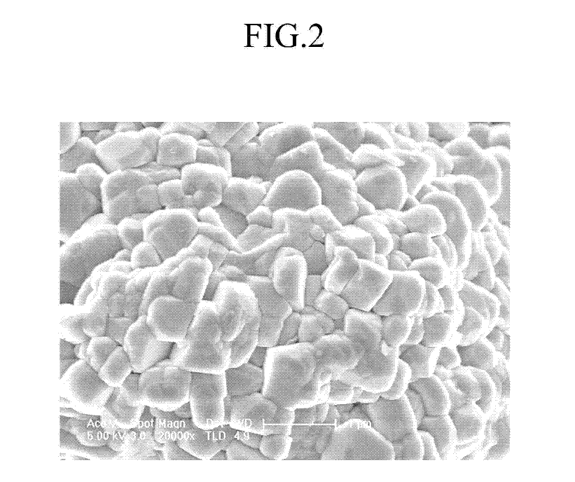

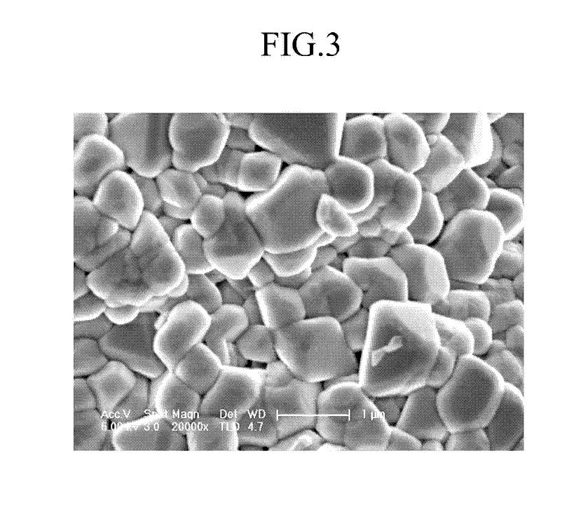

FIG. 2 is a scanning electron microscope (SEM) photograph of the positive active material according to Example 1, and FIG. 3 is a SEM photograph of the positive active material according to Comparative Example 1. Referring to FIGS. 2 and 3, it may be seen that the positive active material according to Example 1 has a structure where the surface of the core is coated with a composite including a phosphate-based compound and a carbon-based compound.

### EXPERIMENTAL EXAMPLE 2

### DSC Graph Analysis of Positive Active Material

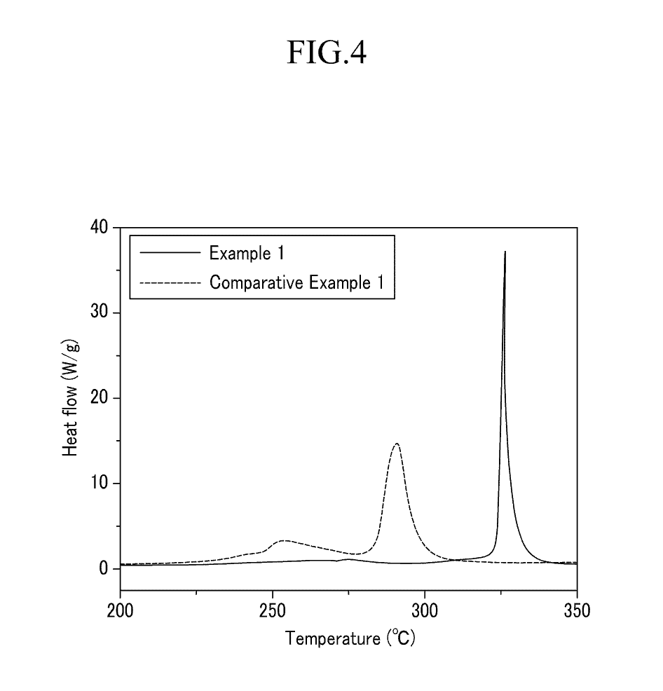

FIG. 4 is a Differential scanning calorimetry (DSC) graph of the positive active materials prepared according to Example 1 and Comparative Example 1. Referring to FIG. 4, the highest peak appears at about 330° C. in Example 1, and in case of Comparative Example 1, the highest peak appears at about 290° C. It may be seen from the result that the positive active material according to one embodiment of this disclosure has excellent thermal stability.

<Manufacturing of Rechargeable Lithium Battery Cell>

Compositions for forming a positive active material layer were prepared by mixing 94 wt % of each of the positive active materials prepared according to Examples 1 and 2 and Comparative Examples 1 to 3, 3 wt % of polyvinylidene fluoride (PVdF) as a binder, and 3 wt % of carbon black as a conductive material, and dispersing the mixture in N-methyl-2-pyrrolidone. Subsequently, the composition was coated on a 15 μm-thick aluminum current collector, dried and compressed to produce a positive electrode.

A coin-type half-cell was manufactured by using metal lithium as a counter electrode of the positive electrode. In this example, an electrolyte prepared by dissolving LiPF₆ 1.15M in a mixed solution of ethylene carbonate (EC) and dimethyl carbonate (DMC) whose volume ratio was 3:3 was used.

### EXPERIMENTAL EXAMPLE 3

### Charge and Discharge Characteristics of Rechargeable Lithium Battery Cell

Charge and discharge characteristics of the cells using the positive active materials prepared according to Examples 1 and 2 and Comparative Examples 1 to 3 were measured and the results are presented in the following Table 1.

The manufactured cells were charged with constant current of about 125 mA/g until they reached about 4.3V (vs. Li) voltage. After reaching about 4.3V voltage, the rechargeable lithium battery cells were charged with constant voltage of about 4.3V until the constant current value decreased to about 1/10. Subsequently, until the cells reached about 3V (vs. Li) voltage, the rechargeable lithium battery cells were discharged with constant current of about 50 mA/g and their discharge capacities were measured. The measured discharge capacity refers to 0.1 C discharge capacity. The charge and discharge were performed three times.

In the fourth cycle, the cells were charged with constant current of about 125 mA/g and constant voltage of about 4.3V until they reached about 4.3V (vs. Li) voltage. Subsequently, the cells were discharged with constant current of about 25 mA/g (0.1 C rate) until they reached about 3V (vs. Li) voltage.

In the fifth cycle, the cells were charged with constant current of about 125 mA/g and constant voltage of about 4.3V until they reached 4.3V (vs. Li) voltage. Subsequently, the cells were discharged with constant current of about 250 mA/g (1 C rate) until they reached about 3V (vs. Li) voltage.

In the sixth to 50th cycles, the cells were charged with constant current of about 125 mA/g and constant voltage of about 4.3V until they reached about 4.3V (vs. Li) voltage. Subsequently, the cells were discharged with constant current of about 125 mA/g (0.5 C rate) until they reached about 3V (vs. Li) voltage.

The charge and discharge experiments were performed at a room temperature of about 25° C.

TABLE 1

| | | Discharge | |
|---|---|---|---|
| | Initial efficiency | capacity ratio | Capacity |
| | (%) | (%)* (1 C/0.1 C) | retention (%)** |
| Example 1 | 90 | 88 | 90 |
| Example 2 | 89.5 | 89 | 89.5 |
| Comparative | 87 | 86 | 85 |
| Example 1 | | | |
| Comparative | 88 | 88 | 89 |
| Example 2 | | | |
| Comparative | 87.5 | 87.5 | 87 |
| Example 3 | | | |

*Discharge capacity ratio (%) denotes the ratio of the discharge capacity at 1 C rate based on the discharge capacity at 0.1 C rate in the first cycle.
**Capacity retention (%) denotes the ratio of the discharge capacity of the 50th cycle based on the discharge capacity of the first cycle.

It may be seen from Table 1 that the cells manufactured using the positive active materials of Examples 1 and 2 in accordance with one embodiment of this disclosure had excellent charge and discharge characteristics, compared with Comparative Examples 1 to 3.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A positive active material, comprising:
a core; and
a composite surrounding a surface of the core and including a phosphate-based compound and a carbon-based compound.

2. The positive active material of claim 1, wherein the core comprises a nickel-based oxide.

3. The positive active material of claim 1, wherein the core comprises a compound represented by the following Chemical Formula 1:
Liₐ(NiₓCo_{y}Mn_{z})₂₋ₐO₂ [Chemical Formula 1]
wherein, 1.01≦a≦1.2, 0.5≦x≦1, 0≦y≦0.5, and 0≦z≦0.5.

4. The positive active material of claim 1, wherein the phosphate-based compound comprises a material selected from a group consisting of Li₃PO₄, P₂O₅, H₃PO₄, (NH₄)₂HPO₄, NH₄H₂PO₄, and a combination thereof.

5. The positive active material of claim 1, wherein the carbon-based compound is obtained from a precursor that comprises a material selected from a group consisting of sucrose, denka black, carbon black and a combination thereof.

6. The positive active material of claim 1, wherein the positive active material has a structure where the surface of the core is coated with the composite.

7. The positive active material of claim 1, wherein the composite is included in an amount of about 0.01 part by weight to about 50 parts by weight based on 100 parts by weight of the core.

8. A method of preparing a positive active material, comprising:
acquiring a first mixture by mixing together a phosphate-based compound and a precursor of a carbon-based compound;
acquiring a second mixture by mixing together the first mixture and a core material; and
heat-treating the second mixture to prepare a positive active material, wherein the core material is surrounded by a composite including the phosphate-based compound and the carbon-based compound.

9. The method of claim 8, wherein the first mixture is acquired by further adding a solvent.

10. The method of claim 8, wherein the heat treatment is performed at a temperature of about 300° C. to about 800° C.

11. The method of claim 8, wherein the core material comprises a nickel-based oxide.

12. The method of claim 8, wherein the phosphate-based compound comprises a material selected from a group consisting of Li₃PO₄, P₂O₅, H₃PO₄, (NH₄)₂HPO₄, NH₄H₂PO₄ and a combination thereof.

13. The method of claim 8, wherein the precursor of the carbon-based compound comprises a material selected from a group consisting of sucrose, denka black, carbon black and a combination thereof.

14. A method of preparing a positive active material, comprising:
acquiring a mixture by mixing together a phosphate-based compound, a precursor of a carbon-based compound and a core material; and
heat-treating the mixture to prepare a positive active material, wherein the core material is surrounded by a composite that includes the phosphate-based compound and the carbon-based compound.

15. The method of claim 14, wherein the heat treatment is performed at a temperature of about 300° C. to about 800° C.

16. The method of claim 14, wherein the core material comprises a nickel-based oxide.

17. The method of claim 14, wherein the phosphate-based compound comprises a material selected from a group consisting of Li₃PO₄, P₂O₅, H₃PO₄, (NH₄)₂HPO₄, NH₄H₂PO₄ and a combination thereof.

18. The method of claim 14, wherein the precursor of the carbon-based compound comprises a material selected from a group consisting of sucrose, denka black, carbon black and a combination thereof.

19. A positive electrode, comprising:
a positive current collector; and
the positive active material of claim 1 arranged on the current collector.

20. A rechargeable lithium battery, comprising:
a positive electrode including a positive current collector and the positive active material of claim 1 arranged on the positive current collector;
a negative electrode including a negative current collector and a negative active material arranged on the negative current collector; and
an electrolyte solution.
